(19) United States
(12) Patent Application Publication
(10) Pub. No.: US 2023/0420176 A1
(43) Pub. Date: Dec. 28, 2023

(54) COIL COMPONENT AND MANUFACTURING METHOD THEREFOR

(71) Applicant: TDK Corporation, Tokyo (JP)

(72) Inventors: Yuuichi KAWAGUCHI, Tokyo (JP); Naoaki FUJII, Tokyo (JP); Tomonaga NISHIKAWA, Tokyo (JP); Liyi CHEN, Tokyo (JP); Mitsuo NATORI, Tokyo (JP)

(21) Appl. No.: 18/330,635

(22) Filed: Jun. 7, 2023

(30) Foreign Application Priority Data
Jun. 24, 2022 (JP) 2022-101694

(51) Int. Cl. H01F 27/28; H01F 41/04; H01F 27/24

(52) U.S. Cl. CPC H01F 27/2804; H01F 41/041; H01F 27/24; H01F 2027/2809

(57) ABSTRACT

Disclosed herein is a coil component that includes a magnetic element body, and a coil part embedded in the magnetic element body. The magnetic element body includes a first region covering the coil part from one side in a coil axis direction, a second region covering the coil part from other side in the coil axis direction, and a third region positioned in an inner diameter area of the coil part so as to connect the first and second regions. The height of the coil part in the coil axis direction decreases toward the inner diameter area.

### BACKGROUND OF THE ART

### Field of the Art

The present disclosure relates to a coil component and a manufacturing method therefor and, more particularly, to a coil component having a structure in which a coil part is embedded in a magnetic element body and a manufacturing method for such a coil component.

### Description of Related Art

JP 2021-052076A discloses a coil component having a structure in which a coil part is embedded in a magnetic element body. According to the technology disclosed in JP 2021-052076A, with the use of a magnetic element body as an element for embedding therein a coil part, a small coil component having high inductance can be provided.

However, the coil component described in JP 2021-052076A has a substantially constant height in the coil axis direction of a coil part, so that a magnetic field perpendicular to the coil axis direction is abruptly bent in the coil axis direction, resulting in an increase in magnetic resistance at a bent part of the magnetic field.

### SUMMARY

It is therefore an object of the present disclosure to provide a coil component having a reduced magnetic resistance at a bent part of a magnetic field and a manufacturing method for such a coil component.

A coil component according to the present disclosure includes a magnetic element body and a coil part embedded in the magnetic element body. The magnetic element body includes a first region covering the coil part from one side in the coil axis direction, a second region covering the coil part from the other side in the coil axis direction, and a third region positioned in the inner diameter area of the coil part so as to connect the first and second regions. The height of the coil part in the coil axis direction decreases toward the inner diameter area.

A manufacturing method for the coil component according to the present disclosure includes: a step of forming a coil part; a step of forming, on one side in the coil axis direction of the coil part and in the inner diameter area of the coil part, a first magnetic element body; a step of deforming the surface on the other side in the coil axis direction of the coil part such that the height in the coil axis direction of the coil part decreases toward the inner diameter area; and a step of forming a second magnetic element body on the other side in the coil axis direction of the coil part.

### BRIEF DESCRIPTION OF THE DRAWINGS

The above features and advantages of the present disclosure will be more apparent from the following description of certain preferred embodiments taken in conjunction with the accompanying drawings, in which:

FIG. 1 is a schematic plan view of a coil component 1 according to a first embodiment of the present disclosure as viewed from a mounting surface side of the coil component 1;

FIG. 2 is a schematic cross-sectional view taken along the line A-A in FIG. 1;

FIG. 3 is a schematic view for explaining a magnetic field generated in the magnetic element body M when current is made to flow in the coil part C;

FIGS. 4 to 18 are process views for explaining the manufacturing method for the coil component 1;

FIG. 19 is a schematic plan view of a coil component 1A according to a first modification;

FIG. 20 is a schematic plan view of a coil component 1B according to a second modification;

FIG. 21 is a schematic cross-sectional view illustrating the configuration of a coil component 2 according to a second embodiment of the present disclosure; and

FIG. 22 is a schematic cross-sectional view illustrating the configuration of a coil component 3 according to a third embodiment of the present disclosure.

### DETAILED DESCRIPTION OF THE EMBODIMENTS

Preferred embodiments of the present disclosure will be explained below in detail with reference to the accompanying drawings.

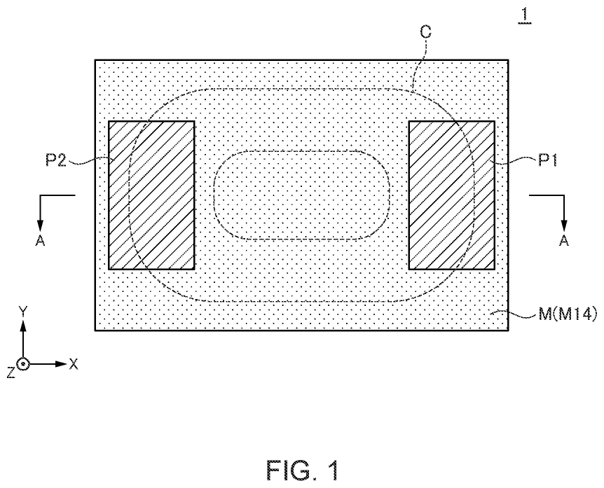

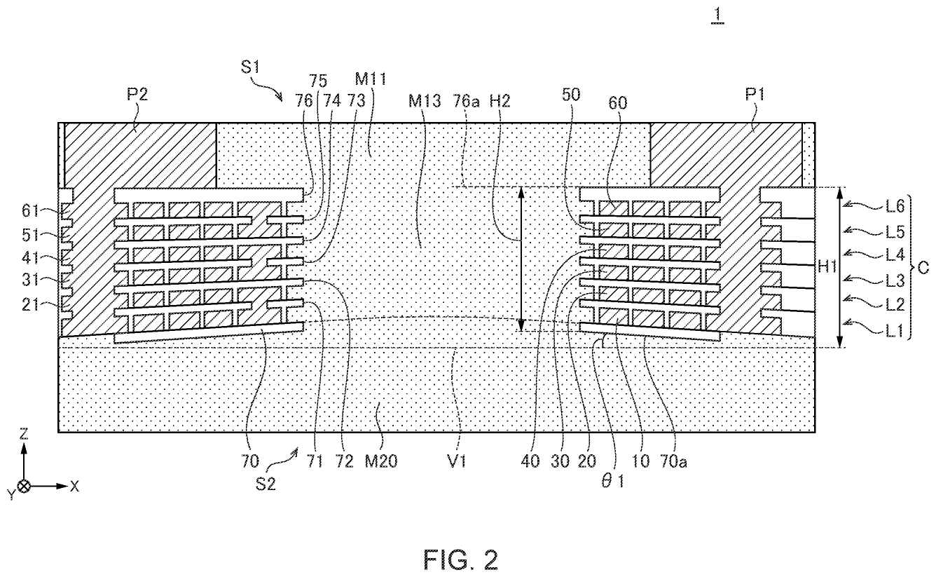

FIG. 1 is a schematic plan view of a coil component 1 according to a first embodiment of the present disclosure as viewed from a mounting surface side of the coil component 1. FIG. 2 is a schematic cross-sectional view taken along the line A-A in FIG. 1.

As illustrated in FIGS. 1 and 2, the coil component 1 according to the present embodiment has a structure in which a coil part C having a coil axis extending in the Z-direction is embedded in a magnetic element body M. The magnetic element body M includes a region M11 covering the coil part C from the positive Z-direction side, a region M20 covering the coil part C from the negative Z-direction, a region M13 connecting the regions M11 and M20, and a region M14 positioned in the outside area of the coil part C. Conductor posts P1 and P2 are embedded in the region M11 of the magnetic element body M.

The coil part C includes interlayer insulating films 70 to 76 and conductor layers L1 to L6 which are alternately stacked in the coil axis direction. The conductor layers L1 to L6 have coil patterns 10, 20, 30, 40, 50, and 60, respectively. The coil patterns 10, 20, 30, 40, 50, and 60 are connected in series to constitute a single coil. One end of the coil is connected to one end (lower end) of the conductor post P1, and the other end thereof is connected to one end (lower end) of the conductor post P2. In the example illustrated in FIG. 2, the outer peripheral end of the coil pattern 60 positioned in the uppermost layer is connected to the conductor post P1, and the outer peripheral end of the coil pattern 10 positioned in the lowermost layer is connected to the conductor post P2 through connection patterns 21, 31, 41, 51, and 61. Other ends (upper ends) of the conductor posts P1 and P2 are exposed from a mounting surface S1. The conductor posts P1 and P2 are conductors that overlap the coil part C as viewed in the coil axis direction and extend in the coil axis direction.

The magnetic element body M is a composite magnetic member containing magnetic metal filler made of iron (Fe) or a permalloy-based material and a resin binder and forms a magnetic path for magnetic flux generated by making a current flow in the coil patterns 10, 20, 30, 40, 50, and 60. The resin binder is preferably epoxy resin of liquid or powder. The magnetic metal filler may be a mixture of a plurality of magnetic metal fillers having different mean particle diameters. This facilitates adjustment of permeability and flowability of the magnetic element body M. The flowability adjustment is important in a to-be-described deformation of the coil part C using water pressure or the like.

As illustrated in FIG. 2, the coil part C has a height (dimension in the coil axis direction) reduced toward the inner diameter area thereof. In other words, assuming that the heights of the coil part C at its outermost and innermost peripheral positions are H1 and H2, respectively, H1>H2 is satisfied. In the example illustrated in FIG. 2, a surface 70a of an interlayer insulating film 70, which constitutes the surface of the coil part C on the other side in the coil axis direction, is inclined with respect to a virtual plane V1 perpendicular to the coil axis. The angle formed by the surface 70a of the interlayer insulating film 70 and the virtual plane V1 is θ1. Thus, in the present embodiment, as the surface 70a of the interlayer insulating film 70 approaches the inner diameter area of the coil part C, it separates farther from a surface S2 on the opposite side from the mounting surface S1. On the other hand, the surface S2 is almost flat and is thus almost perpendicular to the coil axis, so that the region M20 of the magnetic element body M increases in thickness in the coil axis direction toward the inner diameter area of the coil part C.

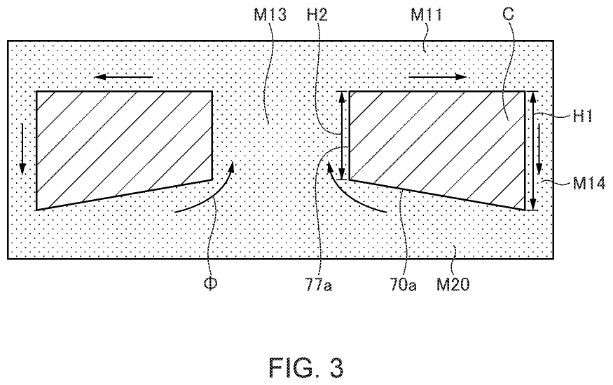

FIG. 3 is a schematic view for explaining a magnetic field generated in the magnetic element body M when current is made to flow in the coil part C.

As illustrated in FIG. 3, when current is made to flow in the coil part C, there is generated a magnetic field circulating in the direction of regions M11→M14→M20→M13 of the magnetic element body M (or in the reverse order). Since H1>H2 is satisfied in the cross-sectional shape of the coil part C in the present embodiment, the surface 70a of the interlayer insulating film 70 and a surface 77a of the inner diameter area of the coil part C form an obtuse angle. Thus, the angle of the magnetic field bent from the region M20 of the magnetic element body M toward the region M13 (or from the region M13 to the region M20) is increased (relaxed) to alleviate concentration of the magnetic field at the corner between the surfaces 70a and 77a, with the result that a magnetic resistance decreases at this portion. The corner between the surfaces 70a and 77a is an area having the highest magnetic flux density and, when the magnetic resistance at this area decreases, inductance significantly increases. In addition, the thickness of the region M20 of the magnetic element body M in the coil axis direction increases toward the inner diameter area. This ensures a sufficient volume of the region M20 of the magnetic element body M, allowing achievement of higher inductance than when H1=H2.

The angle θ1 formed by the surface 70a of the interlayer insulating film 70 and the virtual plane V1 is preferably 0.1° or more and 5° or less. This is because when the angle θ1 is less than 0.1°, a reduction effect of the magnetic resistance is insufficient, and because when using a manufacturing method to be described below, it is difficult to deform the coil part C to such a degree that the angle θ1 exceeds 5°.

The following describes a manufacturing method for the coil component 1 according to the present embodiment.

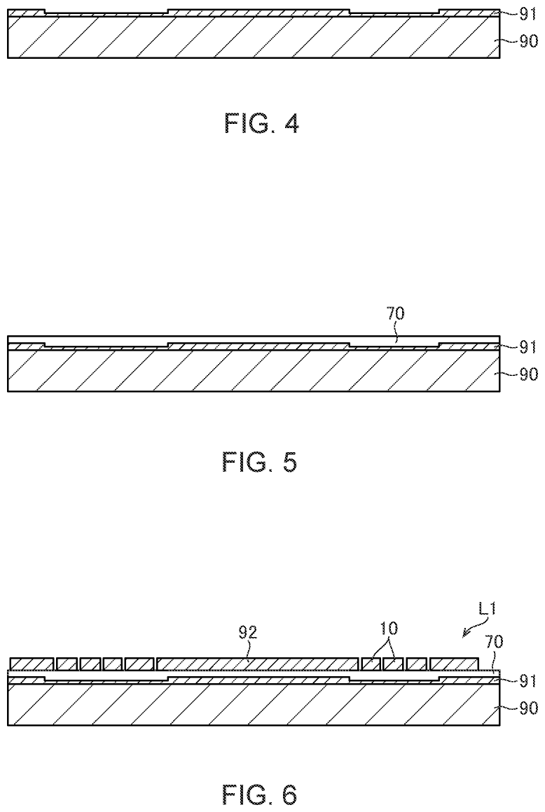

FIGS. 4 to 17 are process views for explaining the manufacturing method for the coil component 1 according to the present embodiment.

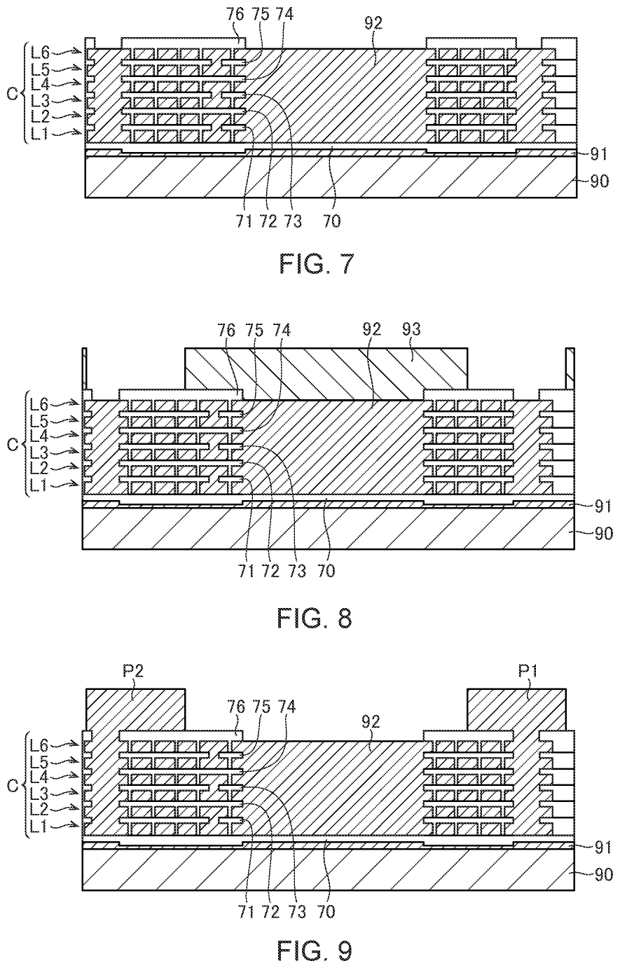

A base material having a copper foil 91 on the surface of a support 90 is prepared and subjected to etching or the like to selectively reduce the film thickness of the copper foil 91 at a position overlapping the coil part C (FIG. 4). Then, the surface of the copper foil 91 is covered with the interlayer insulating film 70 (FIG. 5), and the conductor layer L1 is formed on the surface of the interlayer insulating film 70 (FIG. 6). At this time point, as illustrated in FIG. 6, the conductor layer L1 includes a sacrificial pattern 92. Then, the processes illustrated in FIS. 5 and 6 are repeated to form the coil part C (FIG. 7). The sacrificial patterns 92 included in the respective conductor layers L1 to L6 are not separated by the interlayer insulating films 71 to 75 but contact each other.

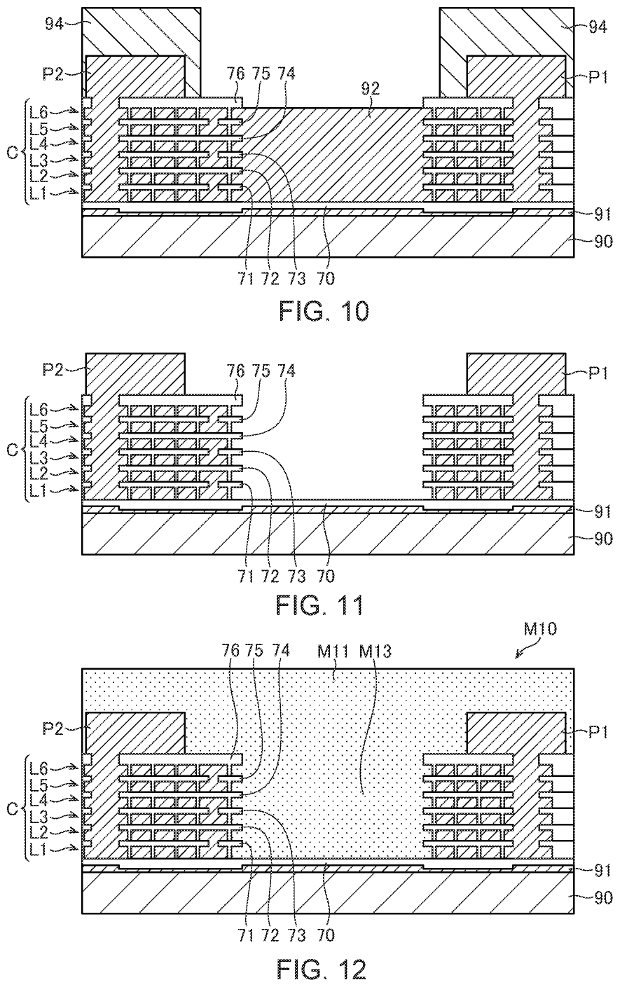

Then, a resist 93 is formed (FIG. 8), followed by electrolytic plating to form the conductor posts P1 and P2 (FIG. 9). As a result, the conductor posts P1 and P2 are provided on one side in the coil axis direction of the coil part C. Then, the conductor posts P1 and P2 are covered with a resist 94 (FIG. 10), and the sacrificial patterns 92 are removed by etching using acid or the like, by laser processing, or other methods (FIG. 11). As a result, the inner diameter area of the coil part C becomes a cavity. The sacrificial pattern 92 is also formed in the outside area of the coil part C (although not illustrated), and by removing this sacrificial pattern 92, the outside area of the coil part C also becomes a cavity.

Then, a magnetic element body M10 having flowability is formed on one side in the coil axis direction of the coil part C, in the inner diameter area of the coil part C, and in the outside area of the coil part C so as to embed therein the coil part C and conductor posts P1 and P2 (FIG. 12). Although the magnetic element body M10 has the region M11 positioned on one side in the coil axis direction of the coil part C, the region M13 positioned in the inner diameter area of the coil part C, and the region M14 positioned in the outside area of the coil part C, only the regions M11 and M13 appear in the cross section illustrated in FIG. 12.

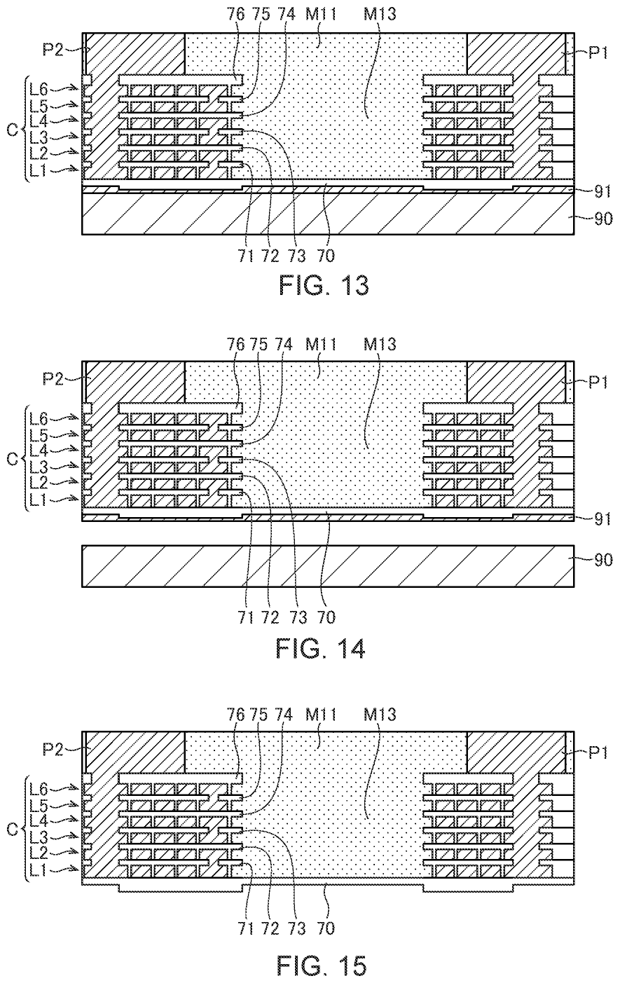

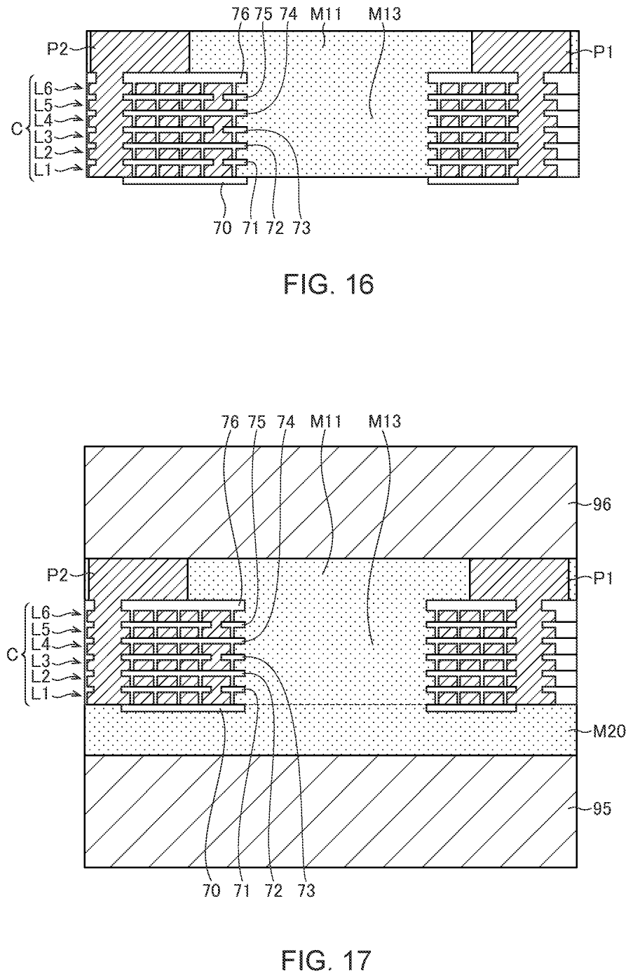

Then, the magnetic element body M10 is temporarily cured, and the surface thereof is ground to expose the surfaces of the conductor posts P1 and P2 (FIG. 13). Thus, at this time point, the surface of the magnetic element body M10 and the surfaces of the conductor posts P1 and P2 are flush with one another. Then, the support 90 is peeled off (FIG. 14), followed by removal of the copper foil 91 by etching to expose the interlayer insulating film 70 (FIG. 15). Subsequently, the interlayer insulating film 70 is subjected to desmear treatment to reduce the film thickness of the interlayer insulating film 70. As a result, the regions M13 and M14 of the magnetic element body M10 positioned in the inner diameter area and outside area of the coil part C are exposed (FIG. 16).

Then, an already cured magnetic element body M20 is stuck to the other side in the coil axis direction of the coil part C (FIG. 17). As a result, the coil part C is sandwiched between the region M11 of the magnetic element body M10 and the magnetic element body M20 in the axis direction, and the magnetic element bodies M10 and M20 are magnetically connected through the regions M13 and M14. Subsequently, in a state being sandwiched by plates 95 and 96, the entire structure is subjected to pressurization using water pressure or the like to cure the temporarily cured magnetic element body 10. As a result, the region M13 of the temporarily cured magnetic element body M10 is compressed. It follows that, as illustrated in FIG. 2, the interface between the regions M13 and M20 is curved and, the coil part C is deformed correspondingly, with the result that the height in the coil axis direction of the coil part C decreases toward the inner diameter area. The regions M11 and M20, which have already been fixed respectively to the plates 95 and 96, have almost no deformation. After that, the magnetic element body M is completely cured and singulated, whereby the coil component 1 according to the present embodiment is obtained.

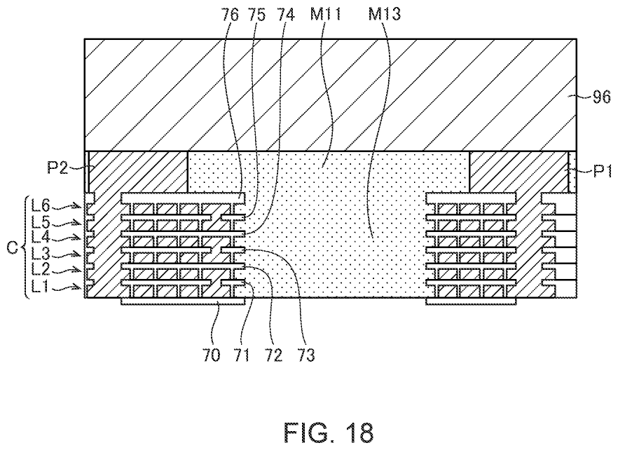

As described above, in the present embodiment, the entire structure is subjected to pressurization using water pressure or the like in a state of being sandwiched by the plates 95 and 96, so that it is possible to deform the coil part C into a shape illustrated in FIG. 2. To further increase the angle θ1 illustrated in FIG. 2, the process illustrated in FIG. 16 is performed, and then, as illustrated in FIG. 18, the entire structure is subjected to pressurization using water pressure or the like with only the region M11 of the magnetic element body M fixed to the plate 96. It follows that the surface of the coil part C on the other side in the coil axis direction is deformed more largely such that the height in the coil axis direction of the coil part C decreases toward the inner diameter area. After the coil part C is thus deformed in advance, the magnetic element body M20 is formed as illustrated in FIG. 17, whereby the volume of the magnetic element body M20 can be increased.

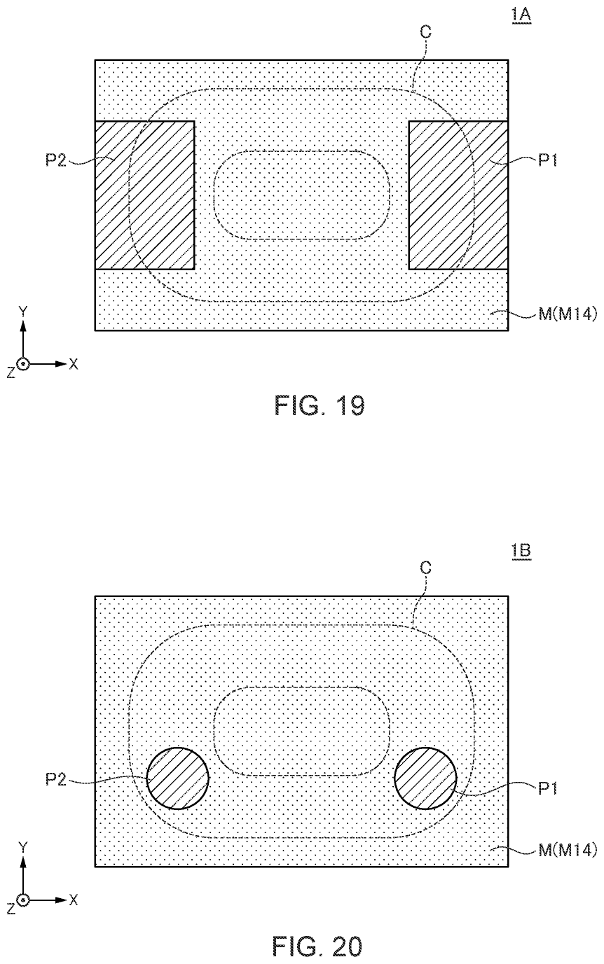

Like a coil component 1A according to a first modification illustrated in FIG. 19, the conductor posts P1 and P2 may each be exposed not only from the mounting surface S1 but also from the YZ surface. With this configuration, when the coil component 1A is mounted on a circuit board, a solder fillet can be formed on the YZ surface. Further, the planar shape of a part of each of the conductor posts P1 and P2 that is exposed to the mounting surface S1 need not be rectangular but may be circular like a coil component 1B according to a second modification illustrated in FIG. 20.

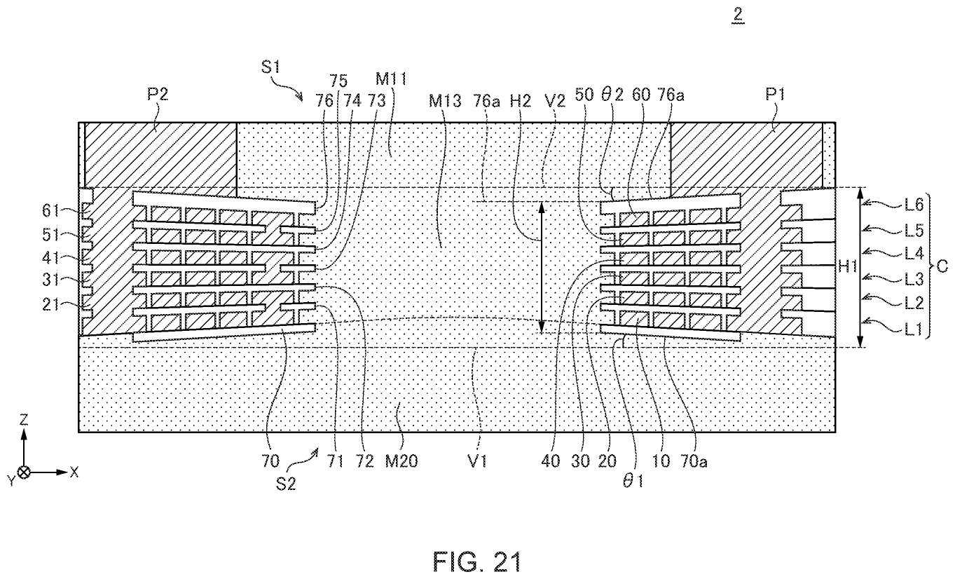

FIG. 21 is a schematic cross-sectional view illustrating the configuration of a coil component 2 according to a second embodiment of the present disclosure.

As illustrated in FIG. 21, the coil component 2 according to the second embodiment differs from the coil component 1 according to the first embodiment in that a surface 76a of the interlayer insulating film 70 constituting the surface of the coil part C on one side in the coil axis direction is inclined with respect to a virtual plane V2 perpendicular to the coil axis. The angle formed by the surface 76a of the interlayer insulating film 76 and the virtual plane V2 is θ2 and is preferably 0.1° or more and 5° or less. Thus, in the present embodiment, as the surface 76a of the interlayer insulating film 70 approaches the inner diameter area of the coil part C, it separates farther from the mounting surface S1. On the other hand, the surface S1 is almost flat and is thus almost perpendicular to the coil axis, so that the region M11 of the magnetic element body M increases in thickness in the coil axis direction toward the inner diameter area of the coil part C. Other basic configurations are the same as those of the coil component 1 according to the first embodiment, so the same reference numerals are given to the same elements, and overlapping description will be omitted.

As exemplified by the present embodiment, the surfaces on both sides in the coil axis direction of the coil part C may be deformed. Thus, the angle of the magnetic field bent from the region M11 of the magnetic element body M toward the region M13 (or from the region M13 to the region M11) is increased (relaxed) to alleviate concentration of the magnetic field at the corner between the surfaces 76a and 77a, with the result that a magnetic resistance decreases at this portion. In addition, a sufficient volume of the region M11 of the magnetic element body M is ensured, allowing achievement of higher inductance.

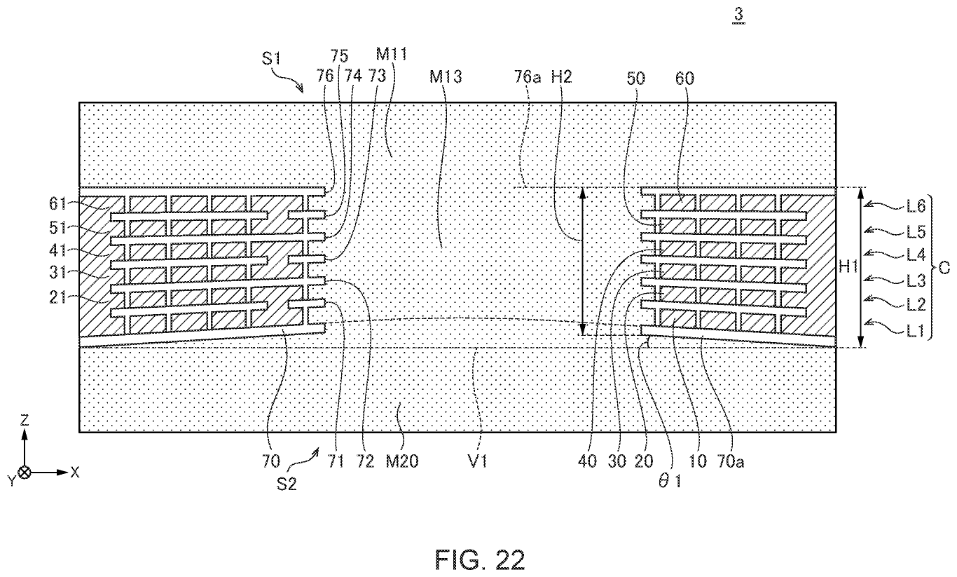

FIG. 22 is a schematic cross-sectional view illustrating the configuration of a coil component 3 according to a third embodiment of the present disclosure.

As illustrated in FIG. 22, the coil component 3 according to the third embodiment differs from the coil component 1 according to the first embodiment in that, in place of omitting the conductor posts P1 and P2, the conductor layers L1 to L6 are partly exposed to the YZ surface of the magnetic element body M and used as a terminal electrode. Other basic configurations are the same as those of the coil component 1 according to the first embodiment, so the same reference numerals are given to the same elements, and overlapping description will be omitted. As exemplified by the present embodiment, the conductor posts P1 and P2 may not necessarily be used in the present disclosure.

While the preferred embodiment of the present disclosure has been described, the present disclosure is not limited to the above embodiment, and various modifications may be made within the scope of the present disclosure, and all such modifications are included in the present disclosure.

For example, the configuration of the coil part C is not limited to that described in the above embodiments, and two coils may be alternately stacked through an interlayer insulating film to constitute a common mode filter.

The technology according to the present disclosure includes the following configuration examples but not limited thereto.

A coil component according to the present disclosure includes a magnetic element body and a coil part embedded in the magnetic element body. The magnetic element body includes a first region covering the coil part from one side in the coil axis direction, a second region covering the coil part from the other side in the coil axis direction, and a third region positioned in the inner diameter area of the coil part so as to connect the first and second regions. The height of the coil part in the coil axis direction decreases toward the inner diameter area.

According to the present disclosure, the height of the coil part in the coil axis direction decreases toward the inner diameter area, so that the angle formed by a magnetic field passing through the first or second region of the magnetic element body and a magnetic field passing through the third region of the magnetic element body is increased (relaxed). This makes it possible to reduce a magnetic resistance at a bent portion of the magnetic field and to ensure a sufficient volume of the magnetic element body.

In the present disclosure, the second region of the magnetic element body may increase in thickness in the coil axis direction toward the inner diameter area. This can increase (relax) the angle formed by a magnetic field passing through the second region and a magnetic field passing through the third region.

The coil component according to the present disclosure may further include a conductor post which is embedded in the first region of the magnetic element body, one end of which is connected to the coil part, and the other end of which is exposed from the first region of the magnetic element body. This makes it possible to mount the coil component on a circuit board such that the coil axis is perpendicular to the circuit board.

In the present disclosure, the first region of the magnetic element body may increase in thickness in the coil axis direction toward the inner diameter area. This can increase (relax) the angle formed by a magnetic field passing through the first region of the magnetic element body and a magnetic field passing through the third region of the magnetic element body.

A manufacturing method for the coil component according to the present disclosure includes: a step of forming a coil part; a step of forming, on one side in the coil axis direction of the coil part and in the inner diameter area of the coil part, a first magnetic element body; a step of deforming the surface on the other side in the coil axis direction of the coil part such that the height in the coil axis direction of the coil part decreases toward the inner diameter area; and a step of forming a second magnetic element body on the other side in the coil axis direction of the coil part.

According to the present disclosure, it is possible to reduce the height in the coil axis of the coil part toward the inner diameter area with a simple method.

As described above, according to the present disclosure, there can be provided a coil component having a reduced magnetic resistance at a bent part of a magnetic field and a manufacturing method for such a coil component.

What is claimed is:

1. A coil component comprising:
a magnetic element body; and
a coil part embedded in the magnetic element body,
wherein the magnetic element body includes a first region covering the coil part from one side in a coil axis direction, a second region covering the coil part from other side in the coil axis direction, and a third region positioned in an inner diameter area of the coil part so as to connect the first and second regions, and
wherein a height of the coil part in the coil axis direction decreases toward the inner diameter area.

2. The coil component as claimed in claim 1, wherein the second region of the magnetic element body increases in thickness in the coil axis direction toward an inner diameter area.

3. The coil component as claimed in claim 1, further comprising a conductor post embedded in the first region of the magnetic element body,
wherein one end of the conductor post is connected to the coil part, and
wherein other end of the conductor post is exposed from the first region of the magnetic element body.

4. The coil component as claimed in claim 2, wherein the first region of the magnetic element body increases in thickness in the coil axis direction toward an inner diameter area.

5. A method for manufacturing a coil component, the method comprising:
forming a coil part;
forming, on one side in a coil axis direction of the coil part and in an inner diameter area of the coil part, a first magnetic element body;
deforming a surface on other side in the coil axis direction of the coil part such that a height in the coil axis direction of the coil part decreases toward the inner diameter area; and
forming a second magnetic element body on the other side in the coil axis direction of the coil part.
